(19) United States
(12) Patent Application Publication
(10) Pub. No.: US 2023/0041629 A1
(43) Pub. Date: Feb. 9, 2023

(54) Preparing Process For Pressing Particulate Aggregates Into A Slab, And Shaping Apparatus

(71) Applicant: Hunan Celiton Technology Co., Ltd., Changsha, Hunan (CN)

(72) Inventor: Shaoliang YANG, Changsha, Hunan (CN)

(21) Appl. No.: 17/789,004

(22) PCT Filed: Dec. 28, 2020
(86) PCT No.: PCT/CN2020/139842

§ 371 Date: Jun. 24, 2022

(30) Foreign Application Priority Data
Dec. 31, 2019 (CN) 201911423028.5

(51) Int. Cl. B28B 3/04; B30B 11/04; B30B 15/30; B30B 15/06; B28B 3/00; B28B 5/02; B28B 7/00

(52) U.S. Cl. CPC B28B 3/04; B30B 11/04; B30B 15/302; B30B 15/062; B28B 3/006; B28B 5/02; B28B 7/0097

(57) ABSTRACT

A preparing process for pressing particulate aggregates into a slab and a shaping apparatus are described. The preparing process includes: mixing particulate aggregates of different sizes and a liquid material as per a preset proportion to obtain a mixture; spreading the mixture flatly in a preset thickness onto a conveyor belt or into a mould frame; vacuumizing the mixture; shaping, wherein a pressing plate is disposed covering the mixture during the shaping procedure to constantly apply a downward pressure against the mixture; a ram disposed over the pressing plate continuously smashes the pressing plate, wherein during ram smashing, the pressure created by the pressing plate forms a continuous holding force to the mixture, the smashing force created from up-down motion of the ram is transferred to the mixture via the pressing plate.

The changes to the abstract are shown below:

A preparing process for pressing particulate aggregates into a slab and a shaping apparatus are described. The preparing process includes: mixing particulate aggregates of different sizes and a liquid material as per a preset proportion to obtain a mixture; spreading the mixture flatly in a preset thickness onto a conveyor belt or into a mould frame; vacuumizing the mixture; shaping, wherein a pressing plate is disposed covering the mixture during the shaping procedure to constantly apply a downward pressure against the mixture; a ram disposed over the pressing plate continuously smashes the pressing plate, wherein during ram smashing, the pressure created by the pressing plate forms a continuous holding force to the mixture, the smashing force created from up-down motion of the ram is transferred to the mixture via the pressing plate.

### TECHNICAL FIELD

Embodiments of the disclosure relate to a preparing process for pressing particulate aggregates into a slab and a shaping apparatus for pressing particulate aggregates into a slab.

### BACKGROUND

Natural stones have already been widely exploited as construction materials since the antient times owing to their versatile colors and ready accessibility. However, due to excess quarrying and low utilization, quarrying of natural stones has been gradually restricted; for example, the European countries have banned quarrying of natural stones. Moreover, the colors and types of the stones produced in different quarries are also unique, which adds difficulty to utilize the stones. Efforts have never been stopped to seek substitutes. With growth of economy and evolution of construction/decoration materials, synthetic stones emerge as new decoration materials. However, it is technically difficult to coordinate between a pressurizing system and a vibrating system of a synthetic stone manufacturing equipment, resulting in complex equipment manufacture, unstable operation, and high maintenance and repair rate, such that mass production can hardly be implemented. Conventional shaping equipment mainly comes in two types: the first type is referred to as pressing and vibrating; and the second type is referred to as ram smashing.

As to the first type, Chinese Utility Patent CN201120319813.9 discloses an artificial quartz press, comprising a base, a rack provided at each flank of the base, a damped spring mounted at the bottom of the base, and an enclosed frame and a ram which are mounted on the base, wherein guide pillars are provided on the base; sleeves are provided over the enclosed frame and the ram, respectively, such that the enclosed frame and the ram are movably attached to the guide pillars via the sleeves; a press top is securely fixed to upper ends of the guide pillars, and a ram hydraulic cylinder and an enclosed frame hydraulic cylinder are disposed on the press top, wherein the ram hydraulic cylinder is connected on the ram via a hydraulic cylinder connecting receptacle, and the enclosed frame hydraulic cylinder is connected on the enclosed frame via a hydraulic cylinder connecting receptacle; a vacuum sealing strip is provided at the bottom of the enclosed frame and the portion of the enclosed frame joining with the ram; a vibration motor is arranged on the ram; driving belts are provided above the racks and the base, and driving wheels are provided at both ends of the driving belts. In that technical solution, pressure is hydraulically applied, and vibration is carried out by the vibration motor. However, such a slab pressing approach has the following drawbacks: since the vibration motor operates with high frequency vibration, the hydraulic system is constantly operating in a pressurizing and releasing cycle, such that the hydraulic pressure is always in a virtual pressure state, failing to apply sufficient pressure to the slab. Meanwhile, that processing approach is similar to kneading, wherein the materials are kneaded like doughs, which cannot enhance slab strength, and considerable time is consumed to shape the slab.

As to the second type, Chinese Invention Patent Application No. 201510026692.1 discloses a method for preparing a synthetic stone by ram smashing and a shaping machine, wherein the shaping machine comprises: a base, a ram mounted on the base; and a drive for driving the ram, wherein the base is provided with a material-holding cell, and the ram is configured to smash the material-holding cell. In that preparing approach, the materials are smashed by the arm; since enough smashing force is applied to the materials, the gaps between particulate aggregates are shrunk as much as possible, thereby enhancing slab strength. That approach can effectively solve the deficiency of the preceding approach. By vertically smashing the particulate or pulverized materials, a high strength slab may be produced. However, as that approach is implemented by vertical smashing, it is highly demanding on proportioning of different grades of the slab compositions. For example, if the grades of slab compositions are proportioned improperly, slab compositions of different sizes likely have inhomogeneous movement amounts upon smashing of the ram, and the resulting slabs are susceptible to cracking, bulging, void forming, and nonlinear motion. The strict requirement on proportioning of the grades of composition results in a demand on high proportioning precision and thus a highly precise production standard; inconsistent motion of slab compositions of different sizes upon ram smashing results in inhomogeneous distribution of slab compositions of different sizes in the slab, as well as deformation of the pressed slab when baking. In that ram smashing solution, a plurality of vibrator drives are synchronously connected to form a synchronous drive group, wherein at least one synchronous drive group is provided on the ram to implement vertical ram smashing. The synchronous drive group has a mechanical structure, while some errors in processing precision, assembly precision, and mechanical operation likely occur, such that the synchronous drive group cannot realize a 100% synchronization, and the materials are always forced towards one side when the slab is smashed during the pressing process, causing the slab thick in one side but thin in the other side. Besides, ram smashing, pressurizing, and vacuumizing are lately developed processes of pressing granular and pulverized materials into a slab, and upon ram smashing, the slab materials easily resonate, such that thin sheet pressing cannot be implemented. The smashing approach may improve the productivity of the slab industry, but seriously affects the yield of slabs. Therefore, a mature slab shaping apparatus and process with a stable yield, an adaptability to mass application, and a fast shaping speed are needed in the slab pressing industry.

### SUMMARY

To overcome the above and other drawbacks in conventional technologies, a preparing process for pressing particulate aggregates into a slab and a shaping apparatus are provided, which produce high-strength slabs and are adapted for massive-scale application.

In some embodiments, a preparing process for pressing particulate aggregates into a slab comprises steps of: A. mixing particulate aggregates of different sizes and a liquid material as per a preset proportion to obtain a mixture; B. spreading the mixture flatly in a preset thickness onto a conveyor belt or into a mould frame; C. vacuumizing the mixture; D. shaping, wherein a pressing plate is disposed covering the mixture during the shaping procedure to constantly apply a downward pressure against the mixture; a ram disposed over the pressing plate continuously smashes the pressing plate, wherein during ram smashing, the pressure created by the pressing plate forms a continuous holding force to the mixture, the smashing force created from up-down motion of the ram is transferred to the mixture via the pressing plate, such that a combined force including the pressure from the pressing plate and the smashing force from the ram acts on the mixture to cause the aggregates in the mixture to move towards each other such that the particulate aggregates of finer sizes fill the gaps between the particulate aggregates of coarser sizes, and cause the liquid material to fill the gaps between the particulate aggregates of different sizes, thereby shaping a compact, dense slab structure; E. curing the shaped slab structure to obtain a final product.

In some embodiments, in the preparing process for pressing particulate aggregates into a slab:

the smashing force created from the ram is evenly distributed upon the mixture via the pressing plate;

the pressure created from the pressing plate includes self-weight force of the pressing plate and the pressure created from vacuumizing;

the pressure created from the pressing plate includes self-weight force of the pressing plate, the pressure created from vacuumizing, and an externally applied pressure;

the ram is in a smooth, unresisted state during the shaping procedure.

In some embodiments, the disclosure provides a shaping apparatus for pressing particulate aggregates into a slab, comprising: a base, a ram mounted on the base, and a drive driving the ram, a material-holding cell being provided on the base, wherein a pressing plate overlying the material-holding cell is further provided, wherein the ram is disposed over the pressing plate; during operation, the pressing plate constantly applies a downward pressure against a mixture in the material-holding cell, and the ram continuously smashes the pressing plate; wherein the pressure created from the pressing plate forms a continuous holding force against the mixture, the smashing force created from up-down motion of the ram is transferred to the mixture in the material-holding cell, and a combined force formed by superimposition of the pressure created by the pressing plate and the smashing force created by the ram acts upon the mixture in the material-holding cell.

In some embodiments, the shaping apparatus for pressing particulate aggregates into a slab further comprises a mould frame, wherein the pressing plate partially enters the mould frame.

In some embodiments, a sealing structure is provided between the mould frame and the base, and a sealing mechanism is provided between the mould frame and the pressing plate, wherein the mould frame, the base, and the pressing plate form a vacuum chamber accommodating the mixture, the vacuum chamber being connected to a vacuumizing system.

In some embodiments, the shaping apparatus for pressing particulate aggregates into a slab further comprises a limit device, the limit device abutting tightly against sidewalls of the ram.

In some embodiments, the shaping apparatus for pressing particulate aggregates into a slab further comprises a limit device disposed on the mould frame, the limit device abutting tightly against sidewalls of the ram.

In some embodiments, a contact rib is provided on the limit device, the contact rib being manufactured by a durable, shock-absorbing material.

In some embodiments, a suspending member is provided on the pressing plate, the suspending member being hooked on the ram, wherein when operating, the suspending member is disengaged from the pressing plate or the ram.

Compared with conventional technologies, the preparing process for pressing particulate aggregates into a slab according to the disclosure offers the following advantages: the disclosure adopts a novel process combining pressing and smashing; during the shaping procedure, the pressing plate is always attached with the mixture without separating from the latter such that the smashing force is only applied against the pressing plate, while the smashing force is transferred to the mixture via the pressing plate. Since the smashing force does not directly act upon the mixture, damages to the mixture upon occurrence of an uneven smashing force can be reduced, thereby reducing cracking. Moreover, the process according to the disclosure can satisfy the requirements of processing thin slabs, preventing occurrence of shaping difficulty in cases that the smashing force is directly applied on the mixture.

Compared with conventional technologies, the shaping apparatus for pressing particulate aggregates into a slab according to the disclosure offers the following advantages: the ram smashing force of the shaping apparatus according to the disclosure only produces a vertical force against the mixture, without a lateral force against the mixture in the horizontal direction; the shaping apparatus according to the disclosure solves the problem of uneven stress subjected to the slab during the pressing and shaping procedures. Besides, the ram smashing force according to the disclosure is not weakened by vacuum.

### BRIEF DESCRIPTION OF DRAWINGS

FIG. 1 is a front view of the disclosure;

FIG. 2 is a left view of the disclosure;

FIG. 3 is a top view of the disclosure;

FIG. 4 is a stereoscopic view of the disclosure;

FIG. 5 is a front sectional view of the disclosure;

FIG. 6 is a side sectional view of the disclosure;

FIG. 7 illustrate sectional views of a ram, a mould frame, and a pressing plate of the disclosure;

FIG. 8 is a stereoscopic view of a mould frame of the disclosure; and

FIG. 9 is an enlarged view of part A in FIG. 6.

### DETAILED DESCRIPTION

To clearly illustrate the solutions in the disclosure, embodiments will be described in detail with reference to the accompanying drawings. It is noted that the embodiments are essentially exemplary, not for limiting the applications or uses of the disclosure. Like reference numerals represent identical or similar components or features throughout the drawings.

A preparing process for pressing particulate aggregates into a slab is provided, comprising steps of:

A. mixing particulate aggregates of different sizes and a liquid material as per a preset proportion to obtain a mixture, wherein particulate aggregates of different sizes and the liquid material are selected and proportioned based on patterns of a vacuum stone, e.g., selecting quartz stone aggregates or other stone particles. The liquid material may be a liquid filler.

B. spreading the mixture flatly in a preset thickness on a conveyor belt or in a mould frame;

C. vacuumizing the mixture;

D. shaping, wherein a pressing plate is disposed covering the mixture during the shaping procedure to constantly apply a downward pressure against the mixture; a ram disposed over the pressing plate continuously smashes the pressing plate, wherein during ram smashing, the pressure created by the pressing plate forms a continuous holding force to the mixture, the smashing force created from up-down motion of the ram is transferred to the mixture via the pressing plate, such that a combined force including the pressure from the pressing plate and the smashing force from the ram acts on the mixture to cause the aggregates in the mixture to move towards each other such that the particulate aggregates of finer sizes fill the gaps between the particulate aggregates of coarser sizes, and cause the liquid material to fill the gaps between the particulate aggregates of different sizes, thereby shaping a compact, dense slab structure;

E. curing the shaped slab structure to obtain a final product.

During the shaping procedure, the disclosure implements shaping by combining the pressing force and the smashing force, thereby effectively resolving the problems existing in conventional technologies of “pressing and vibrating” or “solely smashing.” During the shaping procedure, the pressing plate constantly compresses the mixture tightly to prevent rebound of the mixture when the ram is lifted causing difficulty in shaping, and may also effectively reduce cracking of the mixture. The disclosure has a better effect in processing thin slabs. During a conventional procedure of shaping a thin slab, since the smashing force directly acts on the mixture, the mixture is likely smashed loose to cause cracks due to inhomogeneous thicknesses of the mixture. In the present disclosure, due to provision of the pressing plate, the smashing force indirectly acts on the mixture, which reduces the smashing force's damages on the mixture, reduces cracking, and improves yields.

In this embodiment, the smashing force created from the ram is evenly distributed upon the mixture via the pressing plate. In the disclosure, the pressing plate is a one-piece structure, which enables even distribution of the smashing force, resulting in an even stress subjected to the mixture without occurrence of material agglomeration or material escaping, thereby improving slab yields.

In this example, the pressure created from the pressing plate includes self-weight force of the pressing plate and the pressure created from vacuumizing. In the disclosure, the pressing plate is manufactured by a one-piece steel plate, which has a self-weight large enough to satisfy the pressure demand. Since a vacuum is formed between the pressing plate and the mixture, the atmospheric pressure also acts upon the pressing plate, further increasing the pressure applied by the pressing plate. Of course, in the disclosure, the pressure created by the pressing plate may include the self-weight force of the pressing plate, the pressure created from vacuumizing, and an externally applied pressure. The externally applied pressure may come from an additional hydraulic mechanism that applies a hydraulic pressure against the pressing plate. Of course, a pneumatic mechanism or an extra counterweight may be additionally provided to increase the pressure created from the pressing plate. The structure of the disclosure enables the mixture to be always subjected to enough pressure to maintain a specific state during the shaping procedure, such that when the ram is lifted, the mixture does not rebound.

In this example, the ram is in a smooth, unresisted state during the shaping procedure. In the disclosure, the ram is disposed outside the vacuum chamber such that during its operation, it is not affected by a vacuum force. In addition, during operation, the ram is in a suspended state, such that it may produce a smashing force large enough.

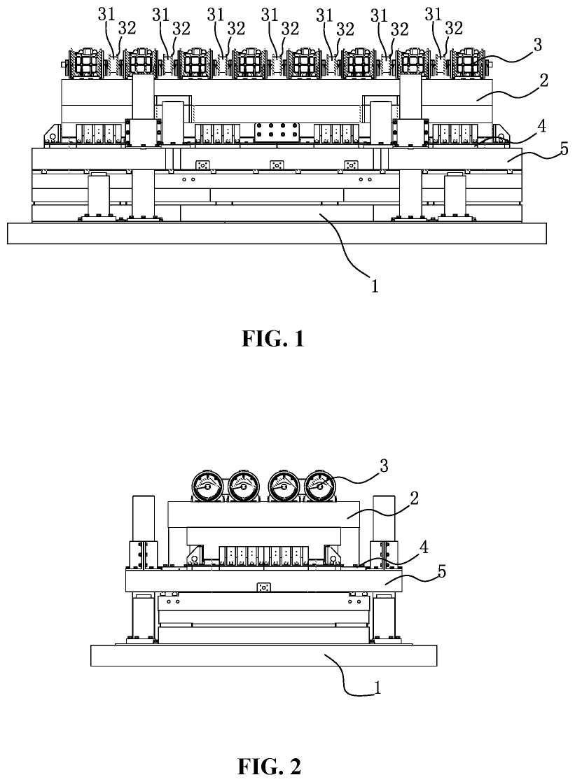

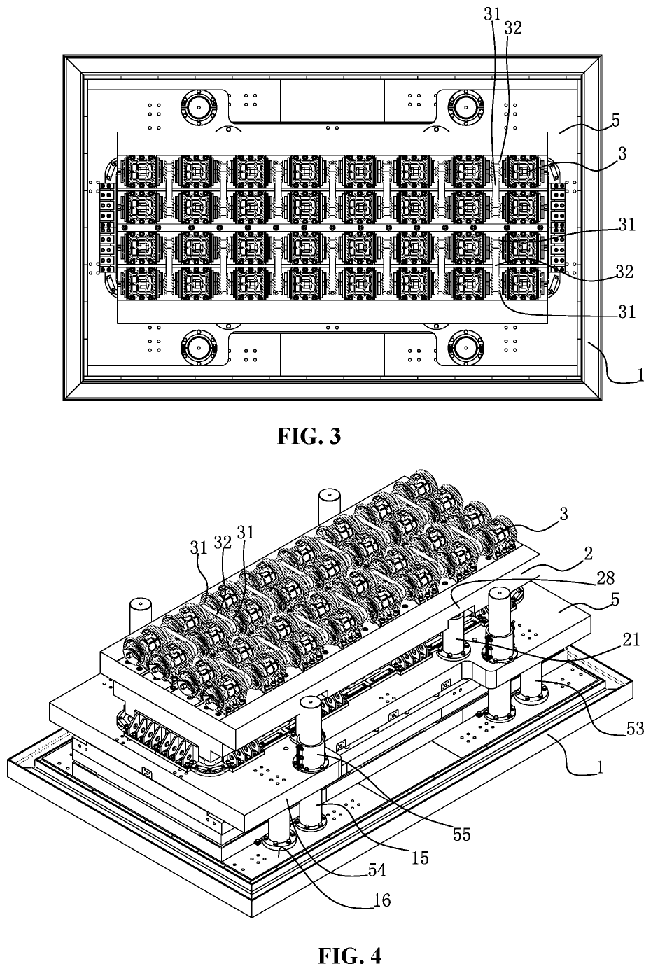

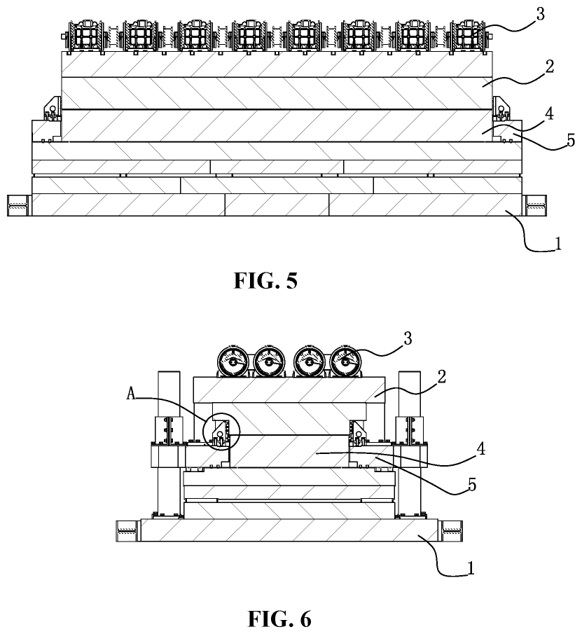

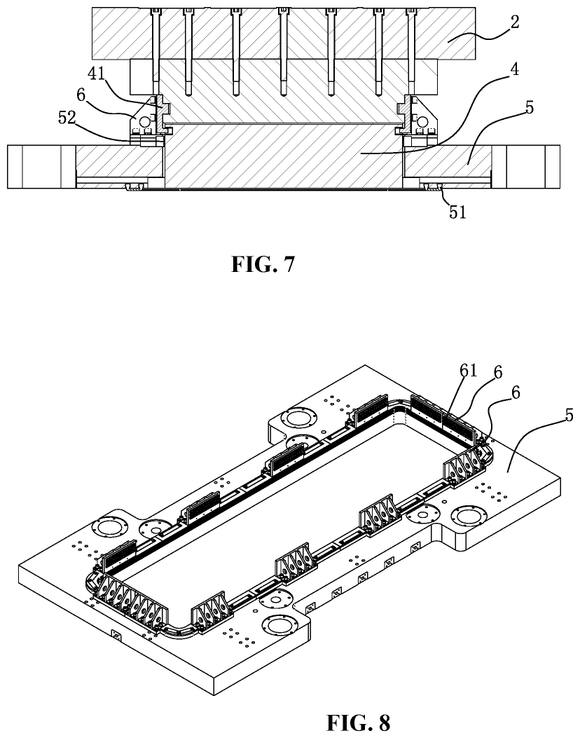

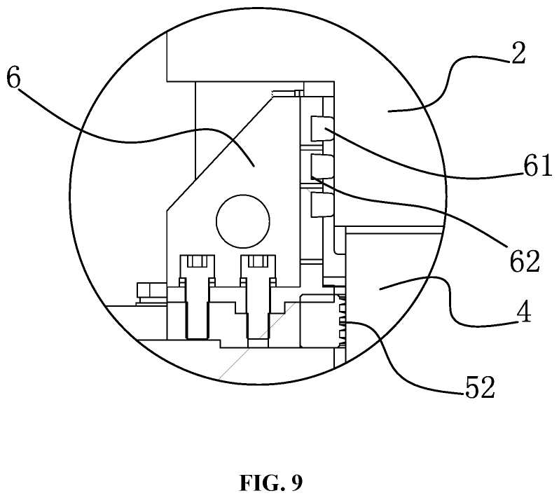

FIGS. 1 to 9 illustrate a shaping apparatus for pressing particulate aggregates into a slab, comprising: a base 1, a ram 2 mounted on the base 1, and a drive 3 driving the ram 2, a material-holding cell provided on the base 1, and a pressing plate 4 overlying the material-holding cell, wherein the ram 2 is disposed over the pressing plate 4; during operation, the pressing plate 4 constantly applies a downward pressure against a mixture in the material-holding cell, the ram 2 continuously smashes the pressing plate 4, the pressure created from the pressing plate 4 creates a continuous holding force against the mixture, the smashing force created from up-down motion of the ram 2 is transferred to the mixture in the material-holding cell, and a combined force formed by superimposition of the pressure created by the pressing plate 4 and the smashing force created by the ram 2 acts on the mixture in the material-holding cell. In the disclosure, a pressing plate structure is additionally provided. The pressing plate 4 is of a plate structure with a size consistent with the mixture, thereby fully covering the mixture. In this example, the pressing plate 4 is manufactured by a steel plate, which has a weight large enough to satisfy the pressure requirement. During operating, the pressing plate 4 constantly presses against the mixture tightly such that the mixture does not rebound, which facilitates fast shaping of the mixture and shortening the shaping time. Since the smashing force indirectly acts on the mixture, the mixture does not rebound. The ram 2 may adopt a higher smashing frequency and apply a higher smashing force to further accelerate the mixture shaping speed, shorten the shaping time, and improve the productivity.

In the example illustrated in FIGS. 1 to 9, the shaping apparatus further comprises a mould frame 5, wherein the pressing plate 4 partially enters the mould frame 5. The mould frame 5 is a frame structure manufactured by metal, playing a role of limiting the mixture, preventing material leakage or material escape. During operating, the pressing plate 5 is at least partially disposed in the mould frame 5, which facilitates tightly pressing the mixture in the mould frame 5.

In the example illustrated in FIGS. 1 to 9, a sealing structure 51 is further provided between the mould frame 5 and the base 1, and a sealing mechanism 52 is further provided between the mould frame 5 and the pressing plate 4, wherein the mould frame 5, the base 1, and the pressing plate 4 form a vacuum chamber accommodating the mixture, the vacuum chamber being connected to a vacuumizing system. In the disclosure, the vacuum chamber is formed by the mould frame 5, the base 1, and the pressing plate 4, wherein the vacuum force may further increase the pressure created from the pressing plate 4. Since the ram 2 is not disposed in the vacuum chamber, the vacuum force has no impact on the ram 2 and does not weaken the smashing force of the ram 2. The sealing structure 51 has at least two laps of sealing rings mounted at the bottom of the mould frame 5, the sealing rings being tightly pressed against the base 1. The sealing mechanism 52 is a toothed sealing ring mounted on sidewalls of the mould frame 5, the toothed sealing ring abutting tightly against the sidewalls of the pressing plate 4.

In the example illustrated in FIGS. 1 to 9, the shaping apparatus further comprises a limit device 6 abutting against sidewalls of the ram 2. The limit device 6 includes multiple groups of limit blocks to play a role of limiting the ram 2, preventing offset of the ram 2 during the smashing procedure such that the created smashing force is an up-down smashing force.

In the example illustrated in FIGS. 1 to 9, the shaping apparatus further comprises a limit device 6 disposed on the mould frame 5, wherein the limit device 6 abuts tightly against a sidewall of the ram 2. In this example, the limit device is provided on the mould frame 5 to play a role of limiting the ram 2.

In the example illustrated in FIGS. 1 to 9, a contact rib 61 is provided on the limit device 6, the contact rib 61 being manufactured by a durable, shock-absorbing material. The contract rib 61 plays a support role to reduce friction with the ram 2. A recessed groove 62 is formed on the limit device 6, and the contact rib 61 is mounted in the recessed groove 62.

In the example illustrated in FIGS. 1 to 9, a suspending member 41 is provided on the pressing plate 4, wherein the suspending member is hooked on the ram, and when operating, the suspending member 41 is disengaged from the pressing plate 4 or the ram 2. In the disclosure, the ram 2 is further provided with a ram hydraulic cylinder 21. The ram hydraulic cylinder 21 has four groups of hydraulic mechanisms, which can lift the ram 2. During the lifting procedure, the suspending member 41 may lift the pressing plate together with the ram 2 so as to separate the pressing plate 4 from the mixture, thereby facilitating conveying of the materials. Of course, the mould frame 5 is provided with a mould frame hydraulic cylinder 53, and the suspending member 41 may also be connected with the mould frame 5, thereby simultaneously moving the pressing plate 4 while lifting the mould frame 5.

In the example illustrated in FIGS. 1 to 9, a plurality of the drives 3 are synchronously connected to form one synchronous drive group. At least four synchronous drive groups are provided on the top of the ram 2, wherein every two synchronous drive groups are connected via a synchronizing mechanism. The synchronizing mechanism comprises a plurality of synchronizing wheels 31 and a plurality of synchronizing belts 32, the synchronizing wheel 31 being mounted between every two adjacent drives 3, each synchronizing wheel 31 being connected with the rotary shaft of the corresponding drive 3. The synchronizing wheels 31 in every two synchronous drive groups are connected via the synchronizing belt 32, thereby realizing synchronous operation between the adjacent two synchronous drive groups. In the disclosure, the synchronizing mechanism comprises a plurality of synchronizing wheels and synchronizing belts, offering a better synchronization effect. In this example, every two of the four synchronous drive groups are synchronous with reverse rotation directions, i.e., one group rotates forward, the other group rotates reversely. This structure offers a better synchronization group. Of course, in the disclosure, the four synchronous drive groups may all be connected via the synchronizing wheels and synchronizing belts, so as to realize synchronization between the four groups. In the disclosure, if there are six synchronous drive groups, three groups thereof are synchronous, and the remaining three groups are synchronous. That is to say, if there are an even number of synchronous drive groups, they are divided by two sets, and each set is synchronous. The synchronizing wheels 31 are toothed wheels, and the synchronizing belts 32 are toothed belts. The synchronizing belts 32 are engaged with the synchronizing wheels 31 to thereby realize synchronous operation.

In the example illustrated in FIGS. 1 to 9, an engraved portion is formed in the middle of the mould frame 5, and a wing plate 54 is formed at each flank edge of the mould frame 5, and a mould frame hydraulic cylinder 53 is provided on the base 1, wherein the mould frame 5 abuts tightly against the wing plates 54. The mould frame 5 plays a role of restraining the materials, such that the mixture of the vacuum stone is placed in the engaged portion without leaking to the peripheries. The mould frame hydraulic cylinder 53 is configured to drive the mould frame 5 to be lifted and lowered, and the wing plates 54 facilitate mounting of the mould frame hydraulic cylinder 53.

In the example illustrated in FIGS. 1 to 9, guide pillars 15 are provided on the base, and a guide canister 55 is provided on each wing plate 54, the guide pillars 15 penetrating into the guide canisters 55. Arrangement of the guide pillars 15 and the guide canisters 55 results in a more stable lifting of the mould frame 5.

In the example illustrated in FIGS. 1 to 9, a step 16 is formed on the base 1, and the mould frame hydraulic cylinder 53 and the guide pillar 15 are disposed on the step 16. Arrangement of the step 16 facilitates mounting and fixing of the mould frame hydraulic cylinder 53 and the guide pillars 15.

In the example illustrated in FIGS. 1 to 9, the upper flank edges of the ram 2 extend outward to form protrusions 28, and the ram hydraulic cylinder 21 abuts tightly against the protrusions 28. This arrangement facilitates the ram hydraulic cylinder 21 to abut against the protrusions 28.

In the example illustrated in FIGS. 1 to 9, the base 1 is formed by superimposition of multiple layers of sheets, and the weight of the base 1 is greater than the pull force of the ram 2. In the disclosure, due to its greater weight, the base 1 is not displaced during the smashing procedure of the ram 2.

In the process example and apparatus example provided above, corresponding contents of the two examples may be referenced with each other. That is, the content in the apparatus example may be used in the process, and the content in the process example may also be used in the apparatus.

In the disclosure, the particulate aggregates move towards each other such that particulate aggregates of finer sizes fill in the gaps between particulate aggregates of coarser sizes under the action of the combined force including the vacuum force, the pressure, and the ram smashing force, and the liquid filler is filled in the gaps between the particulate aggregates; the resulting vacuumized, compact object is referred to as vacuum stone. The shaping apparatus enables particulate aggregates of different sizes to fill relative to each other, wherein particulate aggregates of coarser sizes move towards each other to achieve compactness, the particular aggregates of finer sizes fill the gaps between particulate aggregates of coarser sizes, and the gaps between particulate aggregates of various sizes are filled by filling elements; wherein during the filling procedure of the filling elements, the flexible liquid-filled membranes on the surface of the filling elements are deformed with the sizes and shapes of the gaps, such that all of the gaps are densely filled to evacuate the air in the gaps. The disclosure prepares the vacuum stone according to the principle of Magdeburg hemisphere. The vacuum stone is closer to natural stones, and the overall performance of the vacuum stone is also approximate to the natural stone.

The vacuum stone of the disclosure adopts the following shaping principle: different from conventional technologies in which the synthetic stones are formed by binding of particular aggregates of various sizes using a binding agent such that the resulting synthetic stones have a low strength and are not environmental, the vacuum stones prepared by the disclosure uses atmospheric pressure to press various sizes of particulate aggregates compactly, such that they have a higher strength and are more environmental. The filling concept provided in the disclosure means that particulate aggregates of various sizes move towards each other to become compact, particulate aggregates of finer sizes fill the gaps between particulate aggregates of coarser sizes, and finally the filling elements fill all gaps. The filling process of the disclosure is different from conventional pressing technologies. In the disclosure, particulate aggregates of various sizes can be better bound, thereby achieving the purpose of filling without mixing with a liquid filler, which also reduces use of liquid filler. The liquid filler is only mixed with fine-sized solid granular fillers, thereby forming filling elements of finest sizes; then, the prepared filler elements are used for mixing with the particulate aggregates; in this way, the filler elements will encapsulate various sizes of aggregates. The particulate aggregates encapsulated with the filler elements can be better filled with each other during the shaping procedure, while the gaps therebetween are filled by the filler elements, finally forming a vacuum air-tight body. If various sizes of aggregates were encapsulated with an adhesion agent, the fine-sized aggregates can hardly be filled in the gaps between particulate aggregates during the pressing process. If too much binding agent is applied, excess binding agent can hardly be evacuated from the synthetic stone during the pressing process, and what is finally formed is a synthetic stone structure formed with a binding agent, the strength of which is dictated by the binding strength of the binding agent. Meanwhile, the disclosure does not need sintering the vacuum stone; the sintering-free process is more environment friendly. Therefore, the preparing process provided by the disclosure is a novel process.

The filler elements in the disclosure are obtained by mixing fine-sized solid granular fillers with a liquid filler, wherein a flexible liquid-filled membrane is formed on the surface of the sold granular filling agent. In the disclosure, the fine-sized sold granular fillers are finest-sized filler elements, and the flexible liquid-filled membrane has a malleable appearance such that it may vary with gap sizes, thereby being adapted to different gap sizes to fill the gaps fully and air-tightly.

In the example of the disclosure, the curing refers to turning the liquid filler from liquid to solid. The liquid filler in the disclosure refers to a liquid that may turn from liquid to solid. Such liquid is also required to maintain solid for a long term under normal circumstances to thereby eliminate air in gaps and prevent the air from entering the gaps. The liquid filler, which has a property of turning from liquid to solid, may refer to an organic resin or an inorganic resin. The organic resin includes acrylic resin, unsaturated resin, propylene resin, or epoxy resin; the inorganic resin includes soy-based resin or rubber-based resin. Such liquid fillers have a property of turning from liquid to solid, thereby satisfying requirements of vacuum stones. The liquid filler in the disclosure refers to a liquid having a property of turning from liquid to solid, which is also required to maintain solid in normal conditions to thereby eliminate air in the gaps and prevent air from entering the gap, e.g., various kinds of resin described above. Such resins turn from liquid to solid autonomously or with the aid of a catalyst.

What have been described above are only examples of the disclosure, which are only used for illustrating the principle of the disclosure, not intended for limiting the protection scope of the disclosure. Any modifications, equivalent substitutions or improvements made within the spirits and principles of the disclosure shall fall within the scope of the disclosure.

1. A preparing process for pressing particulate aggregates into a slab, comprising:
mixing particulate aggregates of different sizes and a liquid material as per a preset proportion to obtain a mixture;
spreading the mixture flatly in a preset thickness onto a conveyor belt or into a mould frame;
vacuumizing the mixture;
shaping, wherein a pressing plate is disposed covering the mixture during the shaping procedure to constantly apply a downward pressure against the mixture;
a ram disposed over the pressing plate continuously smashes the pressing plate, wherein during ram smashing, the pressure created by the pressing plate forms a continuous holding force to the mixture, the smashing force created from up-down motion of the ram is transferred to the mixture via the pressing plate, such that a combined force including the pressure from the pressing plate and the smashing force from the ram acts on the mixture to cause the aggregates in the mixture to move towards each other such that the particulate aggregates of finer sizes fill the gaps between the particulate aggregates of coarser sizes, and cause the liquid material to fill the gaps between the particulate aggregates of different sizes, thereby shaping a compact, dense slab structure; and
curing the shaped slab structure to obtain a final product.

2. The preparing process of claim 1, wherein the smashing force created by the ram is evenly distributed on the mixture via the pressing plate.

3. The preparing process of claim 1, wherein the pressure created from the pressing plate includes a self-weight force of the pressing plate and a pressure created by vacuumizing.

4. The preparing process of claim 1, wherein the pressure created from the pressing plate includes a self-weight force of the pressing plate, a pressure created by vacuumizing, and an externally applied pressure.

5. The preparing process of claim 1, wherein the ram is in a smooth, unresisted state during the shaping procedure.

6. A shaping apparatus for pressing particulate aggregates into a slab, comprising:
a base, a ram mounted on the base, and a drive driving the ram, a material-holding cell being provided on the base, wherein a pressing plate overlying the material-holding cell is further provided;
wherein the ram is disposed over the pressing plate; during operation, the pressing plate constantly applies a downward pressure against a mixture in the material-holding cell, and the ram continuously smashes the pressing plate; and
the pressure created from the pressing plate forms a continuous holding force against the mixture, the smashing force created from up-down motion of the ram is transferred to the mixture in the material-holding cell, and a combined force formed by superimposition of the pressure created by the pressing plate and the smashing force created by the ram acts upon the mixture in the material-holding cell.

7. The shaping apparatus of claim 6, further comprising a mould frame, wherein the pressing plate partially enters the mould frame.

8. The shaping apparatus of claim 7, wherein a sealing structure is provided between the mould frame and the base, and a sealing mechanism is provided between the mould frame and the pressing plate, wherein the mould frame, the base, and the pressing plate form a vacuum chamber accommodating the mixture, the vacuum chamber being connected to a vacuumizing system.

9. The shaping apparatus of claim 6, further comprising: a limit device, the limit device abutting tightly against sidewalls of the ram.

10. The shaping apparatus of claim 7, further comprising: a limit device disposed on the mould frame, the limit device abutting tightly against sidewalls of the ram.

11. The shaping apparatus of claim 9, wherein a contact rib is provided on the limit device, the contact rib being manufactured by a durable, shock-absorbing material.

12. The shaping apparatus of claim 6, wherein a suspending member is provided on the pressing plate, the suspending member being hooked on the ram, wherein when operating, the suspending member is disengaged from the pressing plate or the ram.
